(19) United States
(12) Patent Application Publication
(10) Pub. No.: US 2008/0284716 A1
(43) Pub. Date: Nov. 20, 2008

(54) Display Devices With Ambient Light Sensing

(75) Inventors: Martin J. Edwards, Crawley (GB); John Richard Alan Ayres, Reigate (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/096,929

(22) PCT Filed: Nov. 24, 2006
(86) PCT No.: PCT/IB2006/054430

§ 371 Date: Jun. 11, 2008

(30) Foreign Application Priority Data
Dec. 13, 2005 (EP) 05112064.0

(51) Int. Cl. G09G 3/34; G09G 3/36

(52) U.S. Cl. 345/102

(57) ABSTRACT

A method of controlling an illumination source for a display device comprises using an integrated light sensor (14) to detect a light level when the illumination source (12) and light sensor are driven with first drive conditions and using the integrated light sensor to detect a light level when the illumination source (12) and light sensor are driven with second drive conditions, different to the first drive conditions. The first and second detected light levels are processed to derive a first value representing the ambient light level and a second value representing the illumination source output level. This method uses at least two light sensor measurements to derive information concerning both the ambient light levels and the illumination source output level for known drive conditions. This then enables the display device to be controlled taking into account the ambient light level and taking into account the output characteristics of the illumination source.

This invention relates to display devices, for example display devices using illumination light sources, with the display device modulating the light from the illumination light source.

A liquid crystal display is the most common example of this type of modulating display device, and typically comprises an active plate and a passive plate between which liquid crystal material is sandwiched. The active plate comprises an array of transistor switching devices, typically with one transistor associated with each pixel of the display. Each pixel is also associated with a pixel electrode on the active plate to which a signal is applied for controlling the brightness of the individual pixel.

The level of ambient light has a strong influence on the performance of a display device which is used to modulate a light source.

It has been recognized that the performance of displays can be improved by using information from light sensors to modify the operation of the display. For example the intensity of the backlight of the display may be adjusted in response to information from light sensors which are able to sense the characteristics of the ambient illumination as a means of reducing the power consumption of the display when the ambient light levels are low, and to provide a good quality output when the ambient light levels are high.

The required light sensors can be formed as part of the active plate using thin film technology, and this is a convenient way of adding the light sensor capability without requiring additional process steps or separate components. The light sensitive devices may for example be thin film transistors, thin film diodes, lateral diodes or light sensitive resistors. However, in the case where the display makes use of a light source for illumination (this may be a backlight or a frontlight) it can be difficult to optically isolate the light sensors from this light source.

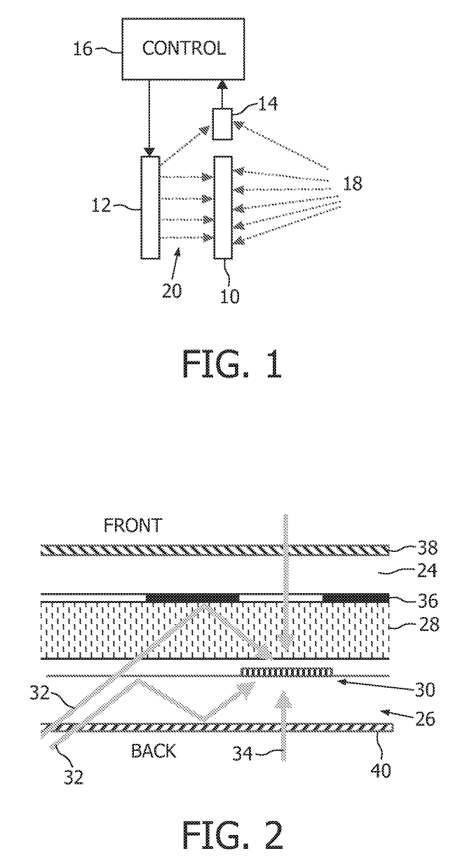

This problem is illustrated in FIG. 1 which shows a display system having a display 10, a backlight 12, a light sensor 14 and control circuitry 16 for operating the display and the backlight. A signal is fed from the light sensor 14 to the controller 16 so that the controller can modify the operation of the display and the backlight in response to changes in the detected illumination.

There will be contributions to the output signal from the sensor 14 which result from the ambient light 18 at the front of the display and from the light 20 generated by the backlight 12. In order to correctly adjust the operation of the display and backlight it is necessary to differentiate between the light from these two sources.

FIG. 2 shows in a simplified form the way in which the light sensors can be integrated within the display. In this example, the display is formed from two glass substrates 24,26 with a liquid crystal layer 28 between them. The light sensor is arranged as an array of light sensor elements 30 which are fabricated on the lower substrate 26 which is closest to the backlight of the display. Ambient light from the front of the display is able to pass through the upper substrate 24 and the liquid crystal layer 28 to reach the light sensor 30.

Light from the backlight is also able to pass through the lower substrate 26 to reach the sensor.

It is possible to block the direct path of light from the backlight to the light sensor, for example by providing an opaque layer at the base of the thin film layers defining the light sensor. However, light from the backlight will be reflected or guided within the substrates of the display and will therefore still reach the sensors via an indirect path. This indirect light path is shown by arrows 32, whereas the direct path is shown as 34.

For completeness, FIG. 2 shows a light masking layer 36. The use of a black mask layer is well known to shield the areas of the active plate through which unmodulated light can pass, and to shield the transistors as their operating characteristics are light-dependent. The top and bottom polarizers 38, 40 are also shown. The black mask layer has an opening to allow ambient light to reach the sensors 30.

It is possible to design further mechanical shielding layers to block as much of the backlight illumination as possible from the light sensors, but this approach increases the complexity of the active plate.

The light sensors can be integrated within the display pixels, or a smaller number of light sensor devices may be provided at the edge of the pixel array.

According to the invention, there is provided a method of controlling an illumination source for a display device, the display device comprising a display modulator for modulating the light provided by the illumination source, the method comprising:

using an integrated light sensor to detect a light level with first illumination source and light sensor drive conditions;

using the integrated light sensor to detect a light level with second illumination source and light sensor drive conditions different to the first drive conditions;

processing the first and second detected light levels to derive a first value representing the ambient light level and a second value representing the illumination source output level; and

controlling the display device using the first and second values.

This method uses at least two light sensor measurements to derive information concerning both the ambient light levels and the illumination source output level for known drive conditions. This then enables the illumination source (or other drive parameters of the display) to be controlled taking into account the ambient light level and taking into account the output characteristics of the illumination source.

The integrated light sensor may comprise a thin film device formed using the same thin film layers used to form a display pixel array, and the light sensor may be arranged as an array of light sensor elements, with one light sensor element integrated into each display pixel.

The first drive conditions may comprise a first output intensity of the illumination source and the second drive conditions comprise a second output intensity of the illumination source. By operating the illumination source with two output levels, the ambient light and illumination source output can be obtained (by solving two simultaneous equations). The first output intensity can comprise zero, namely with the illumination source turned off.

When the illumination source is turned off as one of the measurements, this can conveniently be timed with normal pulse width modulation control of the illumination source. For example, the illumination source can be controlled to provide a desired output level using pulse width modulation control, and the first drive conditions can comprise the zero phase of the pulse width modulation drive scheme.

Instead of having an off condition as one of the drive conditions, the first output intensity can comprises a first non-zero output intensity and the second output intensity comprises a second non-zero output intensity. Again, the solution of two simultaneous equations enables the ambient and illumination source components to be separated.

The first drive conditions can be set at turn on of the display device. Thus, a first measurement can be made initially, and the second measurement can be made during normal use of the display device, without needing any special drive conditions applied to the illumination source.

Instead of using the illumination source intensity as the control parameter, the first drive conditions may comprise illumination for a first time period and the second drive conditions comprise illumination for a second time period, and wherein the light sensor is used to detect an integrated light level. The invention also provides a computer program code means adapted to perform all of the steps of the method of the invention when said program is run on a computer.

The invention also provides a display device comprising:

an illumination source;

a display modulator for modulating the light provided by the illumination source;

an integrated light sensor to detect a light level comprising the combination of a portion of the light from the illumination source and an ambient light component; and

a processor for processing the signals received from the light sensor, wherein the processor is adapted to:
process a first light sensor output representing a light level with first illumination source and light sensor drive conditions and a second light sensor output representing a light level with second illumination source and light sensor drive conditions, different to the first drive conditions, thereby to derive a first value representing the ambient light level and a second value representing the illumination source output level.

An example of the invention will now be described in detail with reference to the accompanying drawings, in which:

FIG. 1 shows a plan view of a known display using light sensing to control the backlight output level, and which can be controlled to implement the method of the invention;

FIG. 2 shows a cross section through a known active matrix liquid crystal display using integrated light sensors, and which can be used in a display device of the invention;

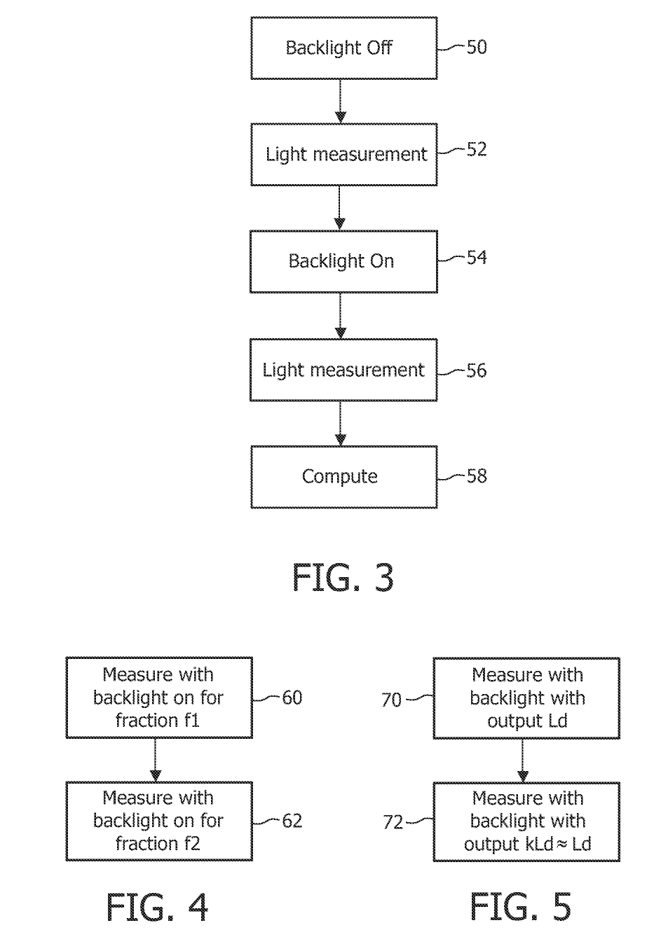

FIG. 3 is used to explain a first control method of the invention;

FIG. 4 is used to explain a second control method of the invention;

FIG. 5 is used to explain a third control method of the invention; and

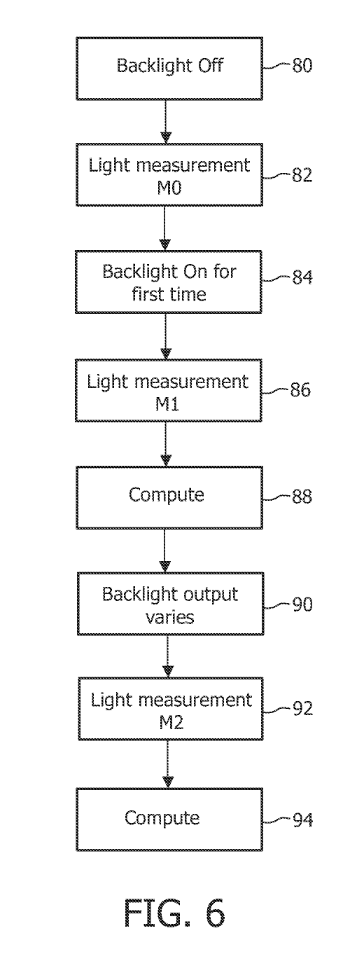

FIG. 6 is used to explain a fourth control method of the invention.

The invention provides a display device in which the of the operation of the light sensors and the operation of the display illumination light source (such as a backlight) is coordinated so that it is possible to differentiate between light detected by the sensors which originates from the backlight and light detected by the light sensors that originates from the ambient environment of the display. This means the physical display design does not need to be optimized to reduce the passage of backlight illumination to the light sensors. The display controller then controls the way in which the display is operating and observes the effect that this change has on the output of the light sensor. This provides information about the relative contributions to the sensor output signal from the ambient light and from the backlight.

FIG. 3 shows the simplest implementation of the method of the invention, which consists of turning the display illumination source off in step 50 and making a measurement of the characteristics of the ambient illumination in step 52. The display illumination source is subsequently turned on in step 54 and a second measurement is made in step 56. The computation in step 58 obtains information about the characteristics of the light generated by the display light source as well as information about the ambient light level.

In the following description (and in the figures), the illumination source will be referred to as the backlight for the sake of clarity, although it will be appreciated that front illumination display systems also exist and the invention is also applicable to such displays. The output of the first measurement 52, M1, represents the response of the sensor to the ambient illumination La and can be expressed as:

M1=LaFa

where Fa is a function which reflects the efficiency of coupling the ambient light to the light sensor and the response of the sensor to that light.

The output of the second measurement 56, M2, represents the response of the sensor to the ambient illumination La and the illumination Ld which it receives from the display backlight. In this case, the output of the measurement can be expressed as:

M2=LaFa+LdFd

where Fd is a function which takes into account the coupling of the light from the display backlight to the ambient light sensor and the response of the sensor to that light. The response of the light sensor to the display backlight alone can be obtained by simply subtracting the first measurement from the second.

LdFd=M2−M1

The two measurements thus enable a measurement of ambient light levels as well as an evaluation of the display backlight performance.

If the main purpose of the light measurements is to detect changes in the illumination conditions over time, for example to compensate for display light source ageing as well as for ambient light conditions, then a relative measurement may be sufficient and it is not necessary to know the functions Fa and Fd.

If an absolute measurement of the display backlight light intensity is required then calibration measurements or estimates of the efficiency of coupling the light to the sensors would be required to evaluate Fa and Fd.

If the displays can be fabricated with sufficient reproducibility then a single calibration measurement or estimation could be performed for a particular display design and the functions obtained applied to all displays of the same design. Alternatively it is possible to calibrate each individual display at manufacture as part of a set up procedure at the factory. The method of FIG. 3 requires an off period for the backlight when a measurement of the ambient illumination is made. This would be seen by a person viewing the display as flicker or variation in the display brightness. The measurement of ambient light intensity can, however, be synchronized with the operation of the backlight when it is operated in a pulsed manner, with the pulse frequency being sufficiently high that the display is not perceived to flicker by the viewer. Such pulse width modulation is known way of varying backlight (or frontlight) output in display devices.

Ambient light measurements are then synchronized to the switching of the backlight so that measurements are made at times when the display backlight is turned off.

In such a pulse width modulation control system, the backlight is switched at a certain frequency and during each period the light source is turned on for a certain fraction of the period and then turned off for the remainder of the period. By changing the fraction of the period for which the backlight is turned on, the average intensity of the backlight can be changed.

The measurement of the ambient light (M1) is thus made during periods when the display backlight is turned off. The second measurement (M2) to determine the characteristics of the display light is made during a period when the display backlight is turned on.

This requires that the light measurement can be made during the relatively short time periods when the display backlight is turned on or turned off. The available time periods depend on the frequency of operation.

There may be insufficient time to perform the light sensing measurements within the pulse width modulation ON period or during the pulse width modulation OFF periods. FIG. 4 shows an alternative method, which relies on the fact that the light sensor measurement will involve integration or averaging of the signal generated by the sensor devices over a period of time, this period of time comprising the duration of the measurement.

FIG. 4 shows in step 60 a first measurement (M1) made over a time period during which the backlight is turned on for a fraction of the measurement period which is equal to f1. Then in step 62 a second measurement (M2) can be made over a time period during which the backlight is turned on for a different fraction of the measurement period f2. Thus, the two measurements have a different ratio of time period with the backlight on to backlight off.

The results of the two measurements can be represented by two equations:

M1=LaFa+f1LdFd

M2=LaFa+f2LdFd

From these two measurements the contributions from the ambient light and the display backlight can be determined as indicated below:

LaFa=(M2f1−M1f2)/(f1−f2)

LdFd=(M1−M2)/(f1−f2)

The two values of f1 and f2 can be achieved by changing the relative timing of the switching of the backlight and the operation of the light sensor circuit to perform a measurement so that the output of the sensor device is integrated or averaged over time periods for which the display backlight has different ratio of on to off time period. The measurements can take place over several cycles of the display backlight switching signal, avoiding the need for light integration over very short time periods.

The change in the ratio between on to off time periods (i.e. the change in fraction) changes the relative contribution from the backlight in a known way, allowing the component to be evaluated. The on period during the two measurements could be the same and it would still be possible to extract the required information if the Off periods for the two measurements were different. This could be achieved by having a different measurement duration for the two measurements. In this case, it is the drive conditions of the backlight during the measurement which change (i.e. the ratio of On to Off time during the measurement changes) but the overall drive conditions of the backlight (the drive frequency and pulse width) are not changed.

FIG. 5 shows a third example in which a similar differentiation between the contributions to the sensor output from the backlight and ambient light can still be made by changing the intensity of the backlight by a small, known amount. This approach may be used when the backlight is operated continuously rather than in a pulsed manner. However, this approach can also be used for pulsed backlights, in which case one way of changing the intensity is to change the pulse width or pulse frequency. The light sensor circuit must then provide an output which represents the average illumination over a period of time, for example a number of periods of the backlight switching frequency. Thus, for a pulsed backlight, the timing of the backlight operation is changed to change the backlight brightness rather than the timing of the measurement as in the example above.

Taking the example of a continuous illumination backlight, in the first measurement 70 the display backlight can for example have an intensity Ld and in a second measurement 72 an intensity k.Ld (approximately equal to Ld). The equations for the two measurements and the calculations of the contributions from the ambient light and from the backlight are as indicated below:

M1=LaFa+LdFd

M2=LaFa+kLdFd

This gives:

LaFa=(M2−kM1)/(1−k)

LdFd=(M1−M2)/(1−k)

In order to provide a sequence of measurements of ambient light intensity and display illumination intensity over time, the change in the brightness of the backlight may be repetitive. In order to minimize the visibility of the change in brightness, the change may be made gradually or in a number of steps rather than being performed in one step. The change may be made over a relatively long period of time, at a low frequency, in which case the change will be difficult for the eye to detect. However, if the period between the first and second measurements is too long then there may be a significant change in the ambient illumination level La and this would result in an incorrect evaluation of LaFa and LdFd.

Alternatively it may be made at a relatively high frequency, above the frequency at which flicker would be perceived by the viewer, in which case the change in backlight intensity may be synchronized to the scanning of the display in order to avoid artifacts in the displayed images.

The photocurrent can be integrated on two capacitors, with the selection of the capacitor to which the photocurrent is applied synchronized to the change in brightness of the backlight. The brightness might for example be switched every row addressing period.

If the light output of the display backlight is relatively stable over time then it is possible to perform the evaluation of the contribution to the sensor output from the backlight less frequently.

This could be done each time the display is turned on or each time that the backlight is switched from a state where it is not in use to one where it is being used.

The output of the light sensors can be recorded just before the display backlight is turned on and a second measurement made just after the display backlight is turned on (or after a time period to allow the display light source to stabilize). The value of LdFd can then be determined and stored. Further changes in the operation of the backlight implemented by the controller can then be taken into account in determining the ambient illumination level from the output of the sensors.

FIG. 6 shows a method using this approach. Initially the backlight is off in step 80. Just before the backlight is turned on for the first time in step 84, a measurement 82 of the light levels is made resulting in a value M0.

Shortly after the display backlight is turned on in step 84 the second measurement 86 results in a value M1.

The initial contribution from the display backlight can be determined from these two measurements as indicated previously, in the computation step 88:

LdFd (at switch on)=M1−M0

Over time, the controller circuit makes a change to the operation of the display backlight so that the illumination level is for example increased to 150% of the value when it was first turned on, as represented by step 90. At this time, a further measurement (M2) is made in step 92 to determine the ambient illumination level.

The effect of the backlight can be eliminated from this measured result by making use of the initial measurement values and the knowledge of the change that has been made to the backlight intensity over time:

M2=LaFa+Ld*Fd

where Ld* represents the current brightness of the display backlight.

M2=LaFa+(150/100)LdFd

M2=LaFa+150(M1−M0)/100

This gives:

LaFa=150(M1−M0)/100−M2

These calculations are made in step 94.

With this approach, the ambient illumination of the display can be determined with a single measurement and without the need to turn off the backlight.

The invention can be implemented using the display designs shown in FIGS. 1 and 2, and provides a different control scheme implemented by the controller 16 for controlling the backlight and providing the computations.

The integrated light sensor comprises a thin film device formed using the same thin film layers used to form a display pixel array, and the light sensor may be arranged as an array of light sensor elements, with one light sensor element integrated into each display pixel.

The invention can be used to implement ambient light sensors in LCD or other light modulating displays with rear or front illumination, and enables control of the illumination source using information concerning both the ambient light levels and the illumination source performance.

A number of possible methods have been described, but it will be apparent that other methods may be employed. The methods can be used where each pixel has a light sensor element, and the measurements are averaged. However, a smaller number of discrete light sensors may be used. As mentioned above, the light sensors may take various forms, for example photodiodes or phototransistors.

The obtained information concerning ambient light levels can be used in known manner to adjust the backlight (or other light source) output to implement power savings in dark ambient light conditions and to ensure good image visibility in bright ambient light conditions. The information concerning the backlight performance can be used in obvious manner, to change the control signal applied to the backlight so that the desired backlight output is obtained even when the transfer function of the backlight changes over time.

In the examples above, the output of the computation is used to control the illumination source of the display, but it might instead or additionally be used to control other aspects of the display operation, for example changing the brightness, contrast or gamma settings of the display, or the refresh frequency.

For clarity, the proposed methods have been described in terms of two discrete measurements being made by the light sensor and the results being used to compute the contributions from the ambient light and from the display light source. This keeps the equations simple. In practice, it may be preferable to use the results from more than two measurements. This may be done to reduce the effect of noise or other errors in the measurements.

One way of performing the required calculations is by a computer program but the same method could be implemented using analogue or digital circuits.

In the simplest case, some averaging of measurement results might be achieved by integrating the output obtained from the light sensing device for a number of measurements. This integration could be performed within the light sensor circuit, for example, by integrating the current from a photodiode onto a capacitor during selected measurement periods. Separate capacitors can be used for the different drive conditions of the illumination source. For example, separate capacitors could be used to integrate the photodiode current during measurements which occur at each of the two display illumination intensity levels.

The voltages established on the two capacitors would then represent the sum of measurements corresponding to each of the illumination intensity levels and could therefore be used to provide the input to the calculations given in the third example of FIG. 5.

More complex computation taking as input a sequence or a set of measurement values sampled over time with different illumination source drive conditions may also be used to improve the quality of the calculated light intensity values, for example by using filtering techniques. Improved performance may for example be obtained by using of a smaller change in illumination source intensity made possible by a lower sensitivity to noise.

In the examples above, the light source output is changed between the two measurements. However, the measurement parameters may instead be changed. For example, the drive conditions of the backlight are not changed in the example above, where it is operated in pulsed mode with the on and off periods and the frequency remaining constant. Instead, the measurement timing is changed. For example, the time for which the backlight is on and off during a measurement time period can be arranged to be different. This can be achieved by changing the timing of the measurement, for example the time period during which the photodiode current is integrated, so that there is a difference in the average brightness of the backlight during the measurement period for each of the two measurements. The ambient light level and backlight level can then be calculated using equations similar to those in the second example above.

If the duration of the two measurements is different, then the output of the two measurements must be scaled in order to take into account the different integration periods and the equations in the second example will be modified accordingly.

As mentioned above, the brightness of the backlight can be changed by adjusting the pulse width or pulse frequency for a given pulse width of a pulsed illumination source output. There are various other ways to provide at least two light sensor measurements from which information concerning ambient light and illumination source performance can be derived.

The invention may be applied to other display types having an illumination source, such as transflective displays.

Various modifications will be apparent to those skilled in the art.

1. A method of controlling an illumination source for a display device, the display device comprising a display modulator for modulating the light provided by the illumination source, the method comprising:
using an integrated light sensor to detect a light level with first illumination source and light sensor drive conditions;
using the integrated light sensor to detect a light level with second illumination source and light sensor drive conditions different to the first drive conditions;
processing the first and second detected light levels to derive a first value representing the ambient light level and a second value representing the illumination source output level; and
controlling the display device using the first and second values.

2. A method as claimed in claim 1, wherein controlling the display device comprises controlling the illumination source.

3. A method as claimed in claim 1, wherein the illumination source and light sensor drive conditions comprise the illumination source drive conditions.

4. A method as claimed in claim 3, wherein the first drive conditions comprise a first output intensity and the second drive conditions comprise a second output intensity.

5. A method as claimed in claim 4, wherein first output intensity comprises zero with the illumination source turned off.

6. A method as claimed in claim 5, wherein the illumination source is controlled to provide a desired output level using pulse width modulation control, and wherein the first drive conditions comprise the zero phase of the pulse width modulation drive scheme.

7. A method as claimed in claim 4, wherein the first output intensity comprises a first non-zero output intensity (Ld) and the second output intensity comprises a second non-zero output intensity.

8. A method as claimed in claim 7, wherein the first drive conditions are set at turn on of the display device.

9. A method as claimed in claim 1, wherein the illumination source and light sensor drive conditions comprise the light sensor drive conditions for a given illumination source output.

10. A method as claimed in claim 1, wherein the first drive conditions comprise illumination for a first time period and the second drive conditions comprise illumination for a second time period, and wherein the light sensor is used to detect an integrated light level.

11. A method as claimed in claim 1, wherein the first drive conditions comprise operating the light sensor with a first duty cycle between the illumination source illuminated and not illuminated and the second drive conditions comprise operating the light sensor with a second duty cycle between the illumination source illuminated and not illuminated.

12. A computer program, embodied on a computer readable medium, for controlling an illumination source for a display device, the computer program causing the acts to be carried out comprising:
using an integrated light sensor to detect a light level with first illumination source and light sensor drive conditions;
using the integrated light sensor to detect a light level with second illumination source and light sensor drive conditions different to the first drive conditions;
processing the first and second detected light levels to derive a first value representing the ambient light level and a second value representing the illumination source output level; and
controlling the display device using the first and second values.

13. (canceled)

14. A display device comprising:
an illumination source;
a display modulator for modulating the light provided by the illumination source;
an integrated light sensor to detect a light level comprising the combination of a portion of the light from the illumination source and an ambient light component; and
a processor for processing the signals received from the light sensor, wherein the processor processes a first light sensor output representing a light level with first illumination source and light sensor drive conditions and a second light sensor output representing a light level with second illumination source and light sensor drive conditions, different to the first drive conditions, to derive a first value representing the ambient light level and a second value representing the illumination source output level.
